(19) United States
(12) Patent Application Publication
(10) Pub. No.: US 2017/0287232 A1
(43) Pub. Date: Oct. 5, 2017

(54) METHOD AND SYSTEM FOR PROVIDING DIRECT FEEDBACK FROM CONNECTED VEHICLES

(71) Applicant: Wipro Limited, Bangalore (IN)

(72) Inventors: Gaurav DEVDUTT, Bangalore (IN); Anindya ROY, Kolkata (IN)

(21) Appl. No.: 15/086,955

(22) Filed: Mar. 31, 2016

(30) Foreign Application Priority Data
Mar. 29, 2016 (IN) 201641010838

(51) Int. Cl. G07C 5/00; G07C 5/08; G07C 5/02; G06F 17/30

(52) U.S. Cl. CPC G07C 5/008; G06F 17/30864; G06F 17/30598; G07C 5/0808; G07C 5/02

(57) ABSTRACT

This disclosure relates generally to providing direct feedback from vehicles and more particularly to a method and system for provisioning direct feedback from connected vehicles.

In one embodiment, a vehicle feedback server for provisioning direct feedback from connected vehicles is disclosed. The vehicle feedback server comprises a processor and a memory communicatively coupled to the processor. The memory stores processor instructions, which, on execution, causes the processor to receive vehicle data from one or more connected vehicles. The processor further enhances the vehicle data with at least one of operating context data, situation context data and activity context data. The processor further clusters the vehicle data into one or more data buckets based on one or more rules. The processor further queries the one or more data buckets based on a query, wherein the query is received from a user.

### PRIORITY CLAIM

This U.S. patent application claims priority under 35 U.S.C. §119 to: TO BE COMPLETED. The aforementioned applications are incorporated herein by reference in their entirety.

### TECHNICAL FIELD

This disclosure relates generally to providing feedback about vehicles and more particularly to a method and system for providing direct feedback from connected vehicles.

### BACKGROUND

The process of selecting a vehicle for purchasing may be challenging, time consuming and confusing because of the abundant choices of vehicles and also lack of relevant information on the various vehicles. A prudent buyer may have to invest a lot of time in researching to find the ideal car, whether new or used, that matches the buyer's personalized requirements. Presently, dealers or Original Equipment Manufacturers (OEMs) of vehicles use traditional advertisements like Above the Line (ATL) and Below the Line (BTL) advertisements and marketing campaigns to attract potential vehicle purchasers. However, these kinds of advertising may not provide the potential buyer with sufficient information to make a decision on which vehicle to purchase.

Potential buyers may generally evaluate a vehicle based on some general parameters. For example, buyers may consider the brand perception of the Auto OEM and may look up reviews and assessment of the vehicles on various online automobile forums to form an opinion about various vehicles they are considering. Further, the potential buyers may seek feedback from their trusted inner circle about the vehicles to come to a decision. However, these methods of evaluating a vehicle are largely based on human perception and may be highly subjective. For example, a person who owns a car from a particular brand may be more inclined to suggest or recommend a car from that brand to a potential buyer. Also the recommendations from trusted inner circle, reviews & social feedback are largely generic and not personalized to the buyer.

### SUMMARY

In an embodiment, the present disclosure illustrates a method of providing direct feedback to a potential buyer from connected vehicles. The method comprises, receiving, by a Vehicle Feedback Server, vehicle data from one or more connected vehicles. The method further comprises, enhancing, by the Vehicle Feedback Server, the vehicle data with at least one of operating context data, situation context data and activity context data. Thereafter, the Vehicle Feedback Server may cluster the vehicle data into one or more data buckets based on one or more rules. The method further comprises, querying, by the Vehicle Feedback Server, the one or more data buckets based on a query, wherein the query is received from a user, thereby providing direct feedback on one or more vehicles to the user based on the query.

In another embodiment, the present disclosure illustrates a Vehicle Feedback Server for providing direct feedback to a potential buyer from connected vehicles. The Vehicle Feedback Server may comprise a processor and a memory communicatively coupled to the processor. The memory stores processor instructions, which, on execution, causes the processor to receive vehicle data from one or more connected vehicles. The processor further enhances the vehicle data with at least one of operating context data, situation context data and activity context data. Subsequently, the processor clusters the vehicle data into one or more data buckets based on one or more rules. The processor further queries the one or more data buckets based on a query, wherein the query is received from a user, thereby providing direct feedback on one or more vehicles to the user based on the query.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates an exemplary network implementation comprising a Vehicle Feedback Sever for providing direct feedback from connected vehicles, according to some embodiments of the present disclosure.

FIG. 2 illustrates a schematic diagram illustrating receiving a query from a user in accordance with some embodiments of the present disclosure.

FIG. 3 is a block diagram that illustrates providing direct feedback from connected vehicles in accordance with some embodiments of the present disclosure.

FIG. 4 is a flow diagram illustrating a method of providing direct feedback from connected vehicles in accordance with some embodiments of the invention.

FIG. 5 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

The present subject matter discloses a method and system for providing direct feedback from connected vehicles. The system and method may be implemented in a variety of computing systems. The computing systems that can implement the described method(s) include, but are not limited to a server, a desktop personal computer, a notebook or a portable computer, hand-held devices, and a mainframe computer. Although the description herein is with reference to certain computing systems, the system and method may be implemented in other computing systems, albeit with a few variations, as will be understood by a person skilled in the art.

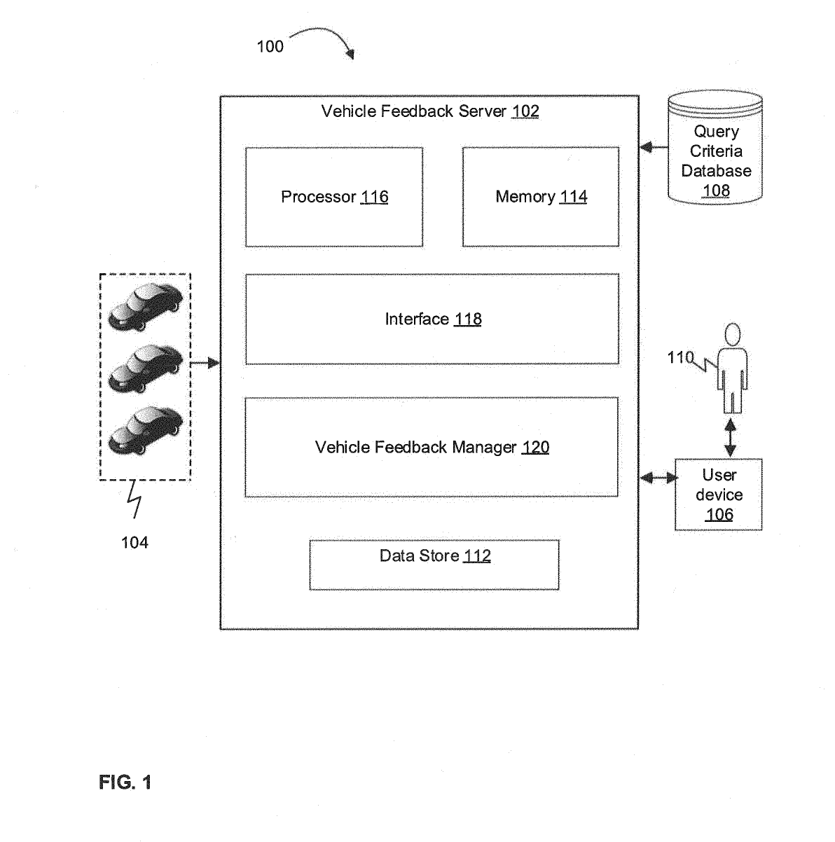

Workings of the methods and system for providing direct feedback from connected vehicles is described in conjunction with FIGS. 1-5. It should be noted that the description and drawings merely illustrate the principles of the present subject matter. It will thus be appreciated that those skilled in the art will be able to devise various arrangements that, although not explicitly described or shown herein, embody the principles of the present subject matter and are included within its spirit and scope. Furthermore, all examples recited herein are principally intended expressly to be only for pedagogical purposes to aid the reader in understanding the principles of the present subject matter and are to be construed as being without limitation to such specifically recited examples and conditions. Moreover, all statements herein reciting principles, aspects, and embodiments of the present subject matter, as well as specific examples thereof, are intended to encompass equivalents thereof. While aspects of the systems and methods can be implemented in any number of different computing systems environments, and/or configurations, the embodiments are described in the context of the following exemplary system architecture(s).

FIG. 1 illustrates an exemplary network environment 100 comprising a Vehicle Feedback Server 102, in accordance with some embodiments of the present disclosure. As shown in FIG. 1, the Vehicle Feedback Server 102, is communicatively coupled to one or more connected vehicles 104, a user device 106 and a Query Criteria Database 108. A user 110 may provide one or more queries to the Vehicle Feedback Server 102 through user device 106. Although the Query Criteria Database 108 is shown external to the Vehicle feedback Server 102 in FIG. 1, it may be noted that, in some implementations, the Query Criteria Database 108 may be present within the Vehicle Feedback Server 102.

The Vehicle Feedback Server 102 may be implemented on variety of computing systems.

The Query Criteria Database 108 may comprise one or more rules that are predefined. This may be obtained from preexisting query criteria knowledge base that gives inclusive or restrictive criterion to cluster the vehicle related data obtained from the one or more connected vehicles 104.

The data store 112 serves as a repository for storing data fetched, processed, received and generated by one or more of the components in the Vehicle Feedback Server 102. In one embodiment, the data may be stored in the memory 114 in the form of various data structures. Additionally, the aforementioned data can be organized using data models, such as relational or hierarchical data models. In an example, the data store 112 may also comprises other data used to store data, including temporary data and temporary files, generated by the components for performing the various functions of the Vehicle Feedback Server 102.

The Vehicle Feedback Server 102 may be communicatively coupled to the user device 106, the connected vehicles 104 and the Query Criteria Database 108 through a network. The network may be a wireless network, wired network or a combination thereof. The network can be implemented as one of the different types of networks, such as intranet, local area network (LAN), wide area network (WAN), the internet, and such. The network may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the network may include a variety of network devices, including routers, bridges, servers, computing devices, storage devices, etc.

As shown in FIG. 1, the Vehicle Feedback Server 102 comprises a processor 116, a memory 114 coupled to the processor 116 and interface(s) 118. The processor 116 may be implemented as one or more microprocessors, microcomputers, microcontrollers, digital signal processors, central processing units, state machines, logic circuitries, and/or any devices that manipulate signals based on operational instructions. Among other capabilities, the processor 116 is configured to fetch and execute computer-readable instructions stored in the memory 114. The memory 114 can include any non-transitory computer-readable medium known in the art including, for example, volatile memory (e.g., RAM), and/or non-volatile memory (e.g., EPROM, flash memory, etc.).

The interface(s) 118 may include a variety of software and hardware interfaces, for example, a web interface, a graphical user interface, etc., allowing the Vehicle Feedback Server 102 to interact with user device 106. Further, the interface(s) 118 may enable the Vehicle Feedback Server 102 to communicate with other computing devices. The interface(s) 118 can facilitate multiple communications within a wide variety of networks and protocol types, including wired networks, for example LAN, cable, etc., and wireless networks such as WLAN, cellular, or satellite. The interface(s) 118 may include one or more ports for connecting a number of devices to each other or to another server.

In order to provide direct feedback from the connected vehicles 104, a Vehicle Feedback Manager 120 may receive vehicle data from the one or more connected vehicles 104 (hereinafter referred to as “connected vehicles”). Here, connected vehicles 104 refer to vehicles that are equipped with network access and may transmit or receive information over the internet or a wireless local area network. The connected vehicles 104 may include vehicles that are used by different owners, which may have the same or different manufacturers and which may be from different locations. One or more sensors onboard the connected vehicles 104 may collect the vehicle data and this data may be transmitted to the Vehicle Feedback Manager 120 from the connected vehicles 104.

Additionally or alternatively, an Engine Control Unit (ECU) associated with each of the connected vehicles 104 may transmit the vehicle data to the Vehicle Feedback Manager 120. Further, a Global Positioning System (GPS) onboard the connected vehicles 104 may provide geospatial information of the connected vehicles 104 to Vehicle Feedback Manager 120. The vehicle data may be received periodically from the connected vehicles 104. The period may be predefined. Further, vehicle owner's smartphone may periodically provide geospatial information of the connected vehicles 104 to Vehicle Feedback Manager 120.

The vehicle data may comprise the operating conditions of the vehicle such as the odometer data that signifies the distance travelled by the vehicle, the tachometer data that determines the rate of rotation of the engine's crankshaft, the speedometer data that gives the speed at which the vehicle is being driven, the engine running parameters that may signify the engine revolution speed, air intake volume and the accelerator depression etc., and the fuel tank conditions that may signify the amount of fuel in a vehicle fuel tank etc. It may also contain Diagnostic Trouble Codes (DTCs) that gives the health condition of the vehicle.

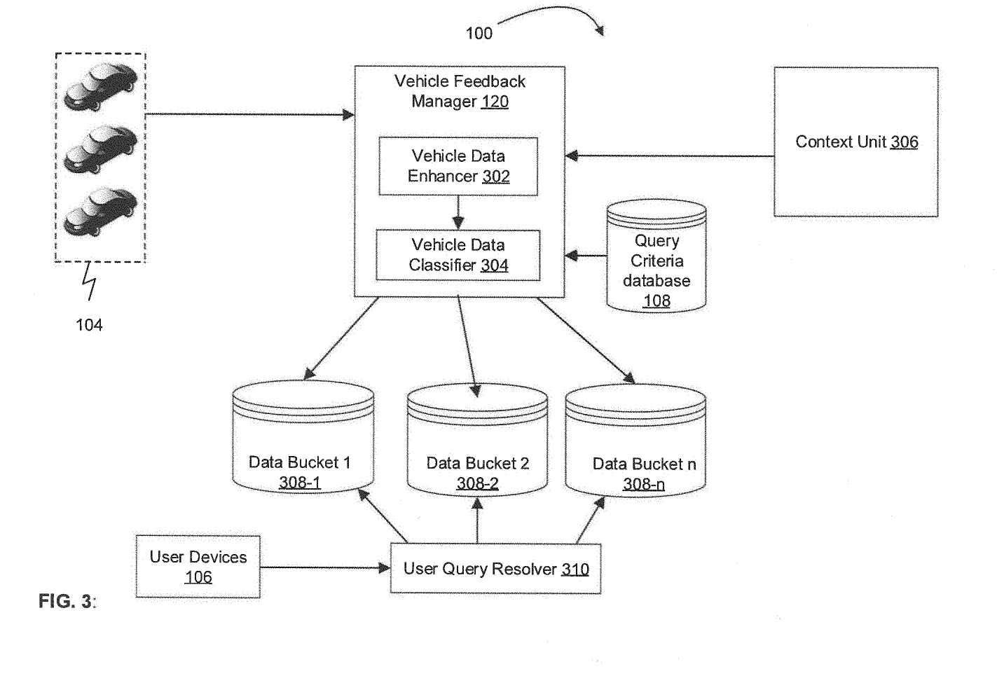

After receiving the vehicle data, the Vehicle Feedback Manager 120 may enhance the vehicle data with context data. The context data may correspond to various conditions that the vehicle was exposed to, when the vehicle data was collected. The context data may include operating context data, situation context data and activity context data. In addition to the context data, the Vehicle Feedback Manager 120 may further enhance the vehicle data using a profile data, wherein the profile data comprises at least one of a vehicle profile or a driver profile. Enhancing the vehicle data by incorporating the context data and the profile data is explained in detail in conjunction with FIG. 3.

After enhancing the vehicle data, the vehicle data may be clustered into one or more data buckets (hereinafter referred to as “data buckets”) based on one or more rules (hereinafter referred to as “rules”). The rules may be predefined in the Query Criteria Database 108. The rules may define various classification criteria based on which the vehicle data is clustered into data buckets. Clustering the vehicle data into one or more data buckets is explained in detail in conjunction with FIG. 3.

The vehicle data may be clustered into data buckets based on traffic data, mileage pattern, city data, build characteristics, demographics like age group, gender, operating conditions, vehicle usage patterns, location data, weather data, a driving style, a driver rating, commuting pattern, a vehicle make, a vehicle model or a vehicle manufacture year. The build characteristics of a vehicle may encompass a wide variety of assembly features that may vary from one vehicle to another. Vehicle color, varying sound systems, air conditioning, anti-lock brakes etc. may be examples for build characteristics. Clustering based on demographics may mean classification of population into certain groups based on age, race, sex, economic status, level of education, income level, employment etc. Demographics such as marital status, economic status etc. may be important information since the choice of the vehicle for purchase may depend upon the demographics that the user belongs to. Examples for the vehicle usage pattern may include “mostly used in city limits in peak hour traffic” or “used on highways” or “used for short distances”, etc. The Vehicle Feedback Manager 120 may determine the vehicle usage pattern by analyzing various parameters associated with the connected vehicle 104 such as location, speed, time of day, etc.

The vehicle data may further be clustered based on the driving styles of drivers associated with the connected cars 104 from which the vehicle data is received. For example, data buckets based on driving styles such as “aggressive”, “cautious”, “responsible”, “passive”, “passive-aggressive”, “eco-friendly”, etc., may be created. The driving style of the driver may be identified based on speed, acceleration, types of maneuvers performed, etc. In one embodiment, these maneuvers may be identified based on any combination of in-vehicle sensors, long-range and short range radars, cameras, Global Positioning System (GPS) map information and vehicle-to-infrastructure or vehicle communication. Examples for in-vehicle sensors may be vehicle speed sensor, a longitudinal acceleration sensor, a steering wheel angle sensor, a steering angle sensor at the wheels etc. The driving style may also be obtained by Geospatial Analysis. The geospatial data may be based on the reception of signals from an array of orbiting satellites. It may also be determined based on the tachometer, speedometer, accelerometer etc. Commuting pattern may give the pattern of commute of the driver, for example, during weekdays and weekends. For instance, the driver may have to commute from home to office during workdays and from home to shopping malls during weekends or may commute long distances trip occasionally. This can be determined by using Global Information Systems (GIS). It may be obtained by analyzing the initial location and the final location and determining the regularity of this data.

Once the vehicle data is clustered into data buckets based on various parameters, the data buckets may be queried by the Vehicle Feedback Manager 120 in response to a query received from user 110 via a user device 106. On receiving the query from the user 110, the Vehicle Feedback Manager 120 may compare the query with one or more predefined query templates (hereinafter referred to as “query templates”). The one or more predefined query templates may be associated with particular data buckets and when a query submitted by the user 110 matches a particular query template, then the query may be served from the data bucket associated with the matched query template. In one embodiment the query from the user 110 may be submitted in the form of statements that can be further parsed. In another embodiment, the query may be submitted in the form of drop down menus, selectable maps of geographies etc. There may be an electronic interface such as a smart hand held device, kiosk, web portal, etc.

Here, query templates may be mapped to the data buckets and may indicate the contents of the data buckets. For example, if a data bucket corresponds to vehicle data associated with drivers that have an “aggressive” driving style, then the query template associated with this data bucket may be tagged with “aggressive driving”. If user 110 submits a query such as “What is a realistic fuel efficiency I can expect from car XYZ if I drive aggressively?” then vehicle data from the data bucket associated with the query template “aggressive driving” may be used to serve the query submitted by the user. It should be noted that in addition to the “aggressive driving” data bucket, a data bucket corresponding to car XYZ may also be accessed by Vehicle Feedback Manager 120 to serve the query submitted by the user 110.

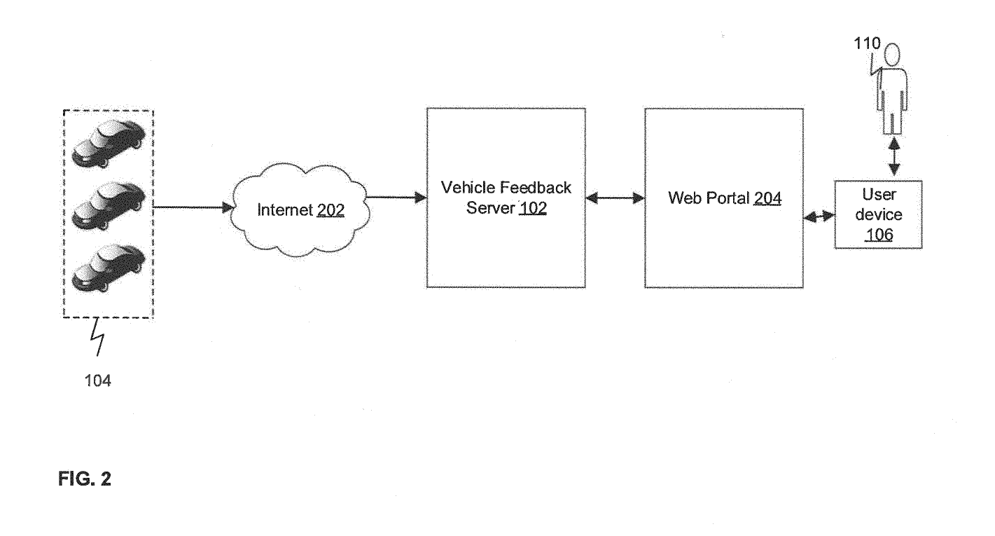

FIG. 2 illustrates a schematic diagram illustrating receiving a query from a user 110 in accordance with some embodiments of the present disclosure. Here, the connected vehicles 104 may be connected to the Vehicle Feedback Server 102 through a network such as Internet 202. User 110 may submit a query on a Web portal 204 using a user device 106. The query may then be routed from the Web Portal 204 to the Vehicle Feedback Server 102. The Vehicle Feedback Server 102 may resolve the query and provide a response to the query as explained in conjunction with FIG. 1.

FIG. 3 illustrates a block diagram for providing direct feedback from connected vehicles 104 in accordance with some embodiments of the present disclosure. One or more sensors (not shown in FIG. 3) associated with the connected vehicles 104 may collect the vehicle data as explained in conjunction with FIG. 1. Vehicle data may be transmitted from connected vehicles 104 by one or more transceivers (not shown in FIG. 3) associated with the one or more connected vehicles 104. In some embodiments, the captured vehicle data may be transmitted through a smart phone (not shown in FIG. 3) associated with a driver of the connected vehicle 104. The vehicle data transmitted by the connected vehicles 104 may be received by Vehicle Feedback Manager 120.

The vehicle data may comprise the operating conditions of the vehicle like the odometer data that signifies the distance travelled by the vehicle, the tachometer data that determines the rate of rotation of the engine's crankshaft, the speed data that gives the speed at which the vehicle is being driven, the engine running parameters that may signify the engine revolution speed, air intake volume and the accelerator depression etc., and the fuel tank conditions that may signify the amount of fuel in a vehicle fuel tank etc. The operating conditions may give an idea of the performance of the vehicle under observation. Vehicle data may also contain Diagnostic Trouble Codes (DTCs) that gives the health condition of the vehicle. DTCs may be an alphanumeric value that corresponds to a particular type of fault in the vehicle and it may be used to diagnose the problem. DTCs may diagnose errors in at least one of engine systems, transmission systems, emissions systems, climate control system, lighting, airbags, antilock brake system, electronic suspension, steering systems and controller area network wiring bus and modules. The DTC obtained may depend on the on board diagnostic system of the connected vehicle 104.

In addition to the vehicle data, the driver of a connected vehicle 104 may input data through voice commands, voice notes, or typed data using a smart phone. The maintenance costs, fuel costs, running costs, average trip costs etc. may be provided as inputs by the drivers of the connected vehicles 104. These inputs by the driver may serve as additional context data associated with the vehicle data. The vehicle data may be enhanced with the context data as explained in conjunction with the Vehicle Data Enhancer 302.

The Vehicle Feedback Manager 120 may comprise a Vehicle Data Enhancer 302 and a Vehicle Data Classifier 304. The Vehicle Data Enhancer 302 may enhance the vehicle data with at least one of context data and profile data. The context data may correspond to various conditions the connected vehicles 104 were exposed to, when the vehicle data was transmitted from the connected vehicles 104. The context data may include operating context data, situation context data and activity context data. The operating context data may include, but is not limited to, a time stamp associated with the vehicle data when the vehicle data was collected by one or more sensors or an Engine Control Unit (ECU) associated with each of the connected vehicles 104, road conditions under which the vehicle was driven when the vehicle data was collected, speed limits associated with the road on which the vehicle was driven, routes taken by the vehicle, altitude data associated with the altitude at which the vehicle was being driven or terrain data associated with the terrain at which the vehicle was being driven or weather data that indicates the weather conditions under which the connected vehicles 104 were operated.

The situation context comprises at least one of the commuting pattern, the vehicle usage pattern, the crash propensity risks of a particular route, parked data that signifies whether the vehicle is parked or moving or the traffic data that signifies the traffic conditions that the connected vehicles 104 are subjected to.

The activity context may include at least one of the gear positions when the vehicle data was collected from the connected vehicles 104, the driving style of the driver, the engine impacts due to the driving style of the driver or the wear and tear thresholds of the connected vehicles 104.

As shown in FIG. 3, a Context Unit 306 may provide context to the Vehicle Data Enhancer 302. The context data may be tagged to the vehicle data in order to provide contextual significance to the vehicle data. In other words, by adding the context to the vehicle data the conditions under which the vehicle data was captured may be factored. Context Unit 306 may include various third party Application Program Interfaces (APIs) such as a Weather API, Geospatial Analysis Unit, Customer Relationship Management (CRM), Government Database, Surveys, 3^{rd} Party data sources and Dealership Management Systems (DMS) and Car Knowledge Base, to provide context to the Vehicle Data Enhancer 302. On receiving the context from the Context Unit 306, the Vehicle Data Enhancer 302 may enhance the vehicle data with the context.

Context Unit 306 may also include a vehicle profile and a driver profile. The vehicle data received from a particular connected vehicle 104 may be enhanced with a vehicle profile associated with the particular connected vehicle 104 and also by a driver profile associated with a driver of the particular connected vehicle 104 by the Vehicle Data Enhancer 302. The vehicle profile may contain static data that is associated with the vehicle. The vehicle profile may comprise at least one of a transmission type, a fuel type, a vehicle make, a vehicle model, a vehicle manufacture year, build characteristics, spare parts status, maintenance status, mileage status, engine risk status, etc. In some embodiments, the vehicle profile may be automatically created for a vehicle from motor vehicle registration information. The spare parts status, the maintenance status, the mileage status, the engine risk status may be obtained from the DMS.

In addition to the vehicle profiles associated with the connected vehicles 104, Context Unit 306 may also include driver profiles of various drivers associated with the connected vehicles 104. The driver profile may comprise at least one of demographic of the driver such as age group, gender etc., driving experience of the driver, a driver rating of the driver based on the driving style of the driver. The Vehicle Data Enhancer 302 may receive context associated with the vehicle data as input from the Context Unit 306 and enhance the vehicle data accordingly.

It will be apparent to a person skilled in the art that enhancing the vehicle data with the context data and the profile data may include tagging the vehicle data with the corresponding context and profile data. However, it is to be understood that the method of enhancing the vehicle data need not be limited to tagging the vehicle data with the context and profile data but may include any known methods of enhancing data.

Once the Vehicle Data Enhancer 302 enhances the vehicle data with context, Vehicle Data Classifier 304 may cluster the vehicle data into data buckets such as data bucket 308-1, data bucket 308-2, . . . data bucket 308-n based on one or more rules (hereinafter referred to as “rules”). The rules may be predefined in the Query Criteria Database 108. The rules may define various classification criteria based on which the vehicle data is clustered into data buckets.

The clustering of the vehicle data into the data buckets 308-1, 308-2, . . . 308-n may comprise clustering the vehicle data based on rules that define various parameters such as the traffic data, the routes taken by the vehicle, fuel economy statistics that gives the miles driven by the vehicle for each gallon of fuel, the mileage pattern, the city data, the build characteristics, the demographics like age groups, gender etc., the vehicle usage pattern, the location, the weather data, the driving style, the operating conditions, the driver rating, the commuting pattern, the vehicle make, the vehicle model or the vehicle manufacture year. The various parameters may include attributes associated with the context of the connected vehicles 104 and attributes from the driver profile or vehicle profile. For example, Vehicle Feedback Manager 120 may cluster vehicle data received from the one or more connected vehicles 104 based on the traffic conditions prevalent when the vehicle data was received from the connected vehicles 104. If the traffic-condition data buckets are broadly defined as low traffic, medium traffic and heavy traffic, then Vehicle Feedback Manager 120 may populate the low traffic bucket with vehicle data that corresponds to vehicles that were driven in low traffic conditions. Similarly, the medium traffic bucket and heavy traffic bucket may include vehicle data received from vehicles driven in medium and heavy traffic conditions respectively. Clustering based on route information may include grouping together vehicle data corresponding to vehicles that travel on similar routes.

The vehicle data may also be grouped based on driver profile attributes such as age and gender. For example, vehicle data corresponding to vehicles driven by male drivers between the age group 20-25 years may be included in a data buckets 308-1, 308-2, . . . 308-n. Similarly, there may be data buckets 308-1, 308-2, . . . 308-n corresponding to male drivers between the ages of 50-60 years and so on.

The vehicle data may further be clustered based on a vehicle profile. For instance, all vehicles of a particular vehicle make may be grouped together. The data bucket 308 corresponding to the particular vehicle make may further be clustered in to data buckets 308-1, 308-2, . . . 308-n corresponding to a vehicle manufacture year, a transmission type, etc. In this way, the clustering of the vehicle data into the data buckets 308-1, 308-2, . . . 308-n may include grouping vehicle data corresponding to similar vehicle attributes into the data buckets 308-1, 308-2, . . . 308-n.

Each data bucket 308 may be associated with a query template, wherein the query template is a collection of restrictive or inclusive criteria. Simple queries can be matched directly with a query template. If the query is complex, then there may be more than one query template that matches the query. In this case, the vehicle data may be retrieved from the plurality of data buckets 308-1, 308-2, . . . 308-n associated with the plurality of query templates, matching the query. The vehicle data that matches the constraints set by the criteria are tagged to the corresponding query template and that data is stored in the corresponding data bucket 308. For instance a query from the user 110 may request the mileage of a car XYZ manufactured in the year 2010, of transmission type automatic. In one embodiment, the data bucket 308 that contains all the vehicle data with respect to car XYZ may be tagged with a query template that relates to the term “XYZ”. Since the query contains the term “XYZ”, this query template shall be matched to the query and the query may be served from the corresponding data bucket 308. This data bucket 308 may contain several other data buckets 308-1, 308-2, . . . 308-n. The query template that relates to only “automatic” transmission type and car “XYZ” may not correspond to the appropriate data bucket 308 since it contains the data for car XYZ with automatic transmission for all the years. Hence the relevant data bucket 308 may be the one that is tagged to the query template which is linked to the terms, “XYZ” “automatic” and “2010”.

A User Query Resolver 310 may translate a human query to set of instructions that can be used to appropriately query the query templates (not shown in FIG. 3). The User Query Resolver 310 compares a query received from user device 106 with one or more query templates associated with data buckets 308-1, 308-2, . . . 308-n. The vehicle data may be retrieved from the one or more data buckets based on matching the query with the query templates.

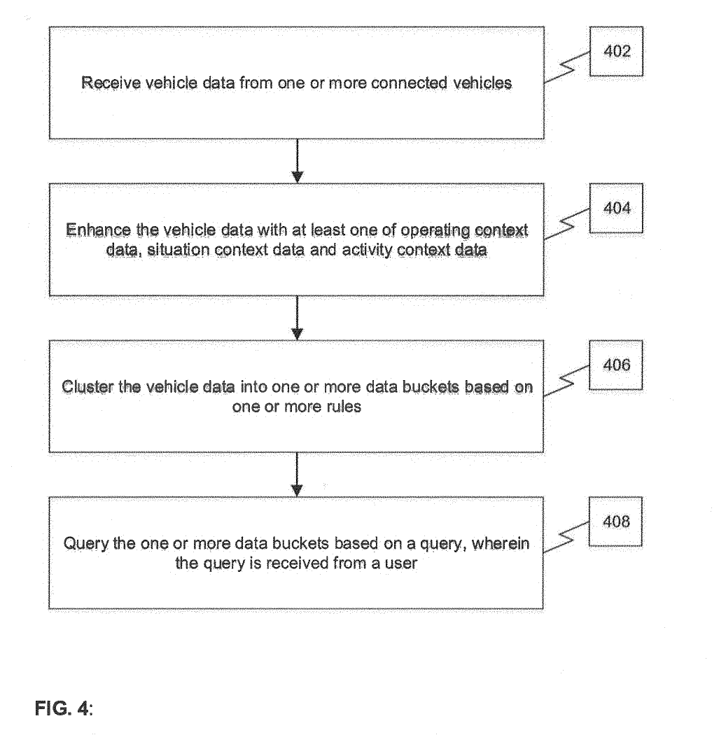

FIG. 4 is a flow diagram illustrating a method of providing direct feedback from connected vehicles 104. With reference to FIG. 4, at step 402, the vehicle data may be received from the connected vehicles 104. The vehicle data may be transmitted to the Vehicle Feedback Manager 120 by one or more transceivers placed in the one or more connected vehicles 104.

The vehicle data may comprise the operating conditions of the vehicle like the odometer data that signifies the distance travelled by the vehicle, the tachometer data that determines the rate of rotation of the engine's crankshaft, the speedometer data that gives the speed at which the vehicle is being driven, the engine running parameters that may signify the engine revolution speed, air intake volume and the accelerator depression etc., and the fuel tank conditions that may signify the amount of fuel in a vehicle fuel tank etc. It may also contain DTCs that gives the health condition of the vehicle.

Once the vehicle data is received it may be enhanced with at least one of the operating context data, the situation context data and the activity context data at step 404. It may further be enhanced with a vehicle profile and a driver profile. The operating context data may comprise at least one of time data, road conditions, speed limits of the routes taken, routes taken by the vehicle, weather data, altitude data or terrain data. The situation context data comprise at least one of crash propensity risks, parked data or traffic data. The activity context may include at least one of the gear positions, driving style, the engine impacts due to the driving style or the wear and tear thresholds. Enhancing the vehicle data may further comprise enhancing the vehicle data with a vehicle profile, wherein the vehicle profile comprises at least one of a transmission type, a fuel type, a vehicle make, a vehicle model, a vehicle manufacture year, build characteristics, spare parts status, maintenance status, mileage status or engine risk status. The transmission type may comprise at least one of manual, automatic, semiautomatic or continuously variable transmissions. Enhancing the vehicle data may further comprise enhancing it with a driver profile, wherein the driver profile comprises at least one of demographics like age groups, gender etc., driving experience, accident history data, a driver rating.

Enhancing the vehicle data may be done by the Vehicle Data Enhancer 302. In one embodiment, the Vehicle Data Enhancer 302 may employ at least one of the Weather API, the Geospatial Analysis Unit, CRM, DMS systems, Car Knowledge Base and other third party APIs to extract at least one of the operating context data, the situation context data, the activity context data, the driver profile and the vehicle profile.

Once the vehicle data has been enhanced, it may be clustered into the one or more data buckets 308-1, 308-2 . . . 308-n, at step 406. Clustering the vehicle data into the one or more data buckets 308-1, 308-2 . . . 308-n comprises clustering the vehicle data based on at least one of the traffic data, routes taken by the vehicle, the mileage pattern, the city data, the build characteristics, the fuel economy statistics, the demographics such as the age groups, gender etc., the vehicle usage pattern, the location, the weather data, the driving style, the operating conditions, the driver rating, the commuting pattern, the vehicle make, the vehicle model or the vehicle manufacture year.

Once the vehicle data has been clustered, the one or more data buckets 308-1, 308-2 . . . 308-n may be queried at step 408. The data buckets 308-1, 308-2 . . . 308-n may be queried based on a query received from the user 110.

The query may be compared with the one or more query templates. The one or more query templates are mapped to the one or more data buckets 308-1, 308-2 . . . 308-n. One or more query templates that matches the query may be identified. The vehicle data, that is corresponding to the at least one of the one or more data buckets 308-1, 308-2 . . . 308-n that are associated with the matched query template, may be retrieved.

### Computer System

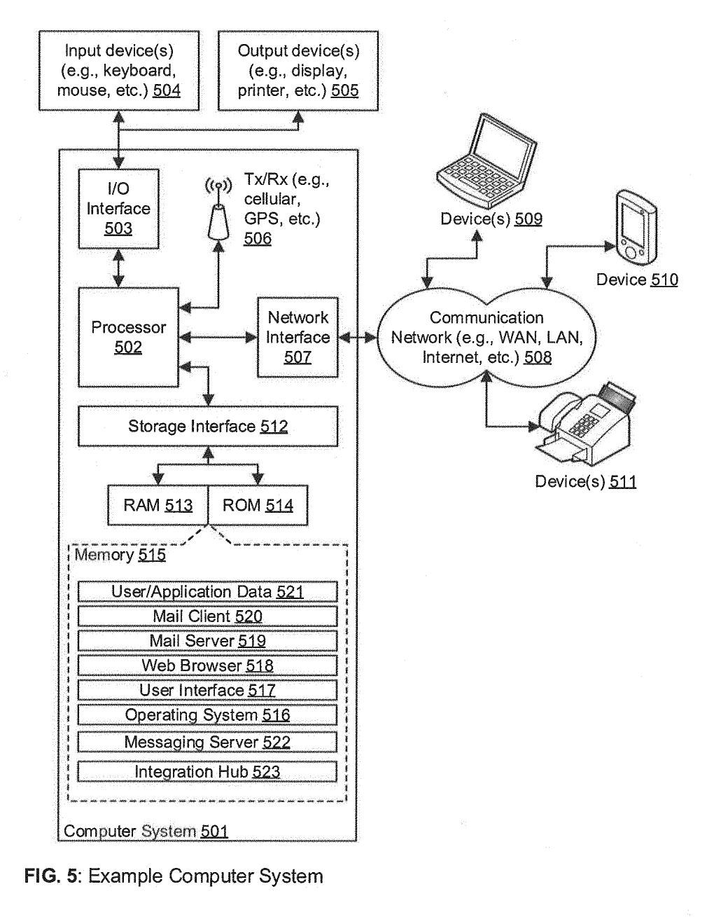

FIG. 5 is a block diagram of an exemplary computer system for implementing embodiments consistent with the present disclosure. Variations of computer system 501 may be used for implementing the Vehicle Feedback Manager 124. Computer system 501 may comprise a central processing unit (“CPU” or “processor”) 502. Processor 502 may comprise at least one data processor for executing program components for executing user- or system-generated requests. A user 110 may include a person, a person using a device such as such as those included in this disclosure, or such a device itself. The processor may include specialized processing units such as integrated system (bus) controllers, memory management control units, floating point units, graphics processing units, digital signal processing units, etc. The processor may include a microprocessor, such as AMD Athlon, Duron or Opteron, ARM application, embedded or secure processors, IBM PowerPC, Intel's Core, Itanium, Xeon, Celeron or other line of processors, etc. The processor 502 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 502 may be disposed in communication with one or more input/output (I/O) devices via I/O interface 503. The I/O interface 503 may employ communication protocols/methods such as, without limitation, audio, analog, digital, monoaural, RCA, stereo, IEEE-1394, serial bus, universal serial bus (USB), infrared, PS/2, BICC, coaxial, component, composite, digital visual interface (DVI), high-definition multimedia interface (HDMI), RF antennas, S-Video, VGA, IEEE 802.n /b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 503, the computer system 501 may communicate with one or more I/O devices. For example, the input device 504 may be an antenna, keyboard, mouse, joystick, (infrared) remote control, camera, card reader, fax machine, dangle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 505 may be a printer, fax machine, video display (e.g., cathode ray tube (CRT), liquid crystal display (LCD), light-emitting diode (LED), plasma, or the like), audio speaker, etc. In some embodiments, a transceiver 506 may be disposed in connection with the processor 502. The transceiver may facilitate various types of wireless transmission or reception. For example, the transceiver may include an antenna operatively connected to a transceiver chip (e.g., Texas Instruments WiLink WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, the processor 502 may be disposed in communication with a communication network 508 via a network interface 507. The network interface 507 may communicate with the communication network 508. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 508 may include, without limitation, a direct interconnection, local area network (LAN), wide area network (WAN), wireless network (e.g., using Wireless Application Protocol), the Internet, etc. Using the network interface 507 and the communication network 508, the computer system 501 may communicate with devices 509, 510, and 511. These devices may include, without limitation, personal computer(s), server(s), fax machines, printers, scanners, various mobile devices such as cellular telephones, smartphones (e.g., Apple iPhone, Blackberry, Android-based phones, Windows based phones etc.), tablet computers, eBook readers (Amazon Kindle, Nook, etc.), laptop computers, notebooks, gaming consoles (Microsoft Xbox, Nintendo DS, Sony PlayStation, etc.), vehicle connected devices such as embedded Telematics Console Units (TCUs), onboard dongles, head units or the like. In some embodiments, the computer system 501 may itself embody one or more of these devices.

In some embodiments, the processor 502 may be disposed in communication with one or more memory devices (e.g., RAM 513, ROM 514, etc.) via a storage interface 512. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory devices may store a collection of program or database components, including, without limitation, an operating system 516, user 106 interface application 517, web browser 518, mail server 519, mail client 520, user/application data 521, messaging server 522, integration hub 523 (e.g., any data variables or data records discussed in this disclosure), etc. The operating system 516 may facilitate resource management and operation of the computer system 501. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 517 may facilitate display, execution, interaction, manipulation, or operation of program components through textual or graphical facilities. For example, user interfaces 517 may provide computer interaction interface elements on a display system operatively connected to the computer system 501, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 501 may implement a web browser 518 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the computer system 501 may implement a mail server 519 stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 501 may implement a mail client 520 stored program component. The mail client may be a mail viewing application, such as Apple Mail, Microsoft Entourage, Microsoft Outlook, Mozilla Thunderbird, etc.

In some embodiments, computer system 501 may store user/application data 521, such as the data, variables, records, etc. as described in this disclosure. Such databases may be implemented as fault-tolerant, relational, scalable, secure databases such as Oracle or Sybase. Alternatively, such databases may be implemented using NO SQL databases or standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

The specification has described application title. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for providing dynamic vehicle feedback, the method comprising:
receiving, by a vehicle feedback server, vehicle data from one or more connected vehicles;
enhancing, by the vehicle feedback server, the vehicle data with at least one of operating context data, situation context data and activity context data;
clustering, by the vehicle feedback server, the vehicle data into one or more data buckets based on one or more rules; and
querying, by the vehicle feedback server, the one or more data buckets based on a query, wherein the query is received from a user.

2. The method as claimed in claim 1, wherein the vehicle data comprises at least one of operating conditions of the vehicle or Diagnostic Trouble Codes (DTCs).

3. The method as claimed in claim 1, wherein the operating context data comprises at least one of time data, road conditions, speed limits, routes, weather data, altitude data or terrain data.

4. The method as claimed in claim 1, wherein the situation context data comprises at least one of commuting pattern, vehicle usage pattern crash propensity risks, parked data or traffic data.

5. The method as claimed in claim 1, wherein the activity context data comprises at least one of gear positions, driving style, engine impacts due to the driving style or wear and tear thresholds.

6. The method as claimed in claim 1, wherein enhancing the vehicle data further comprises enhancing the vehicle data with a vehicle profile, wherein the vehicle profile comprises at least one of a transmission type, a fuel type, a vehicle make, a vehicle model, a vehicle manufacture year, build characteristics, spare parts status, maintenance status, mileage status or engine risk status.

7. The method as claimed in claim 1, wherein enhancing the vehicle data further comprises enhancing the vehicle data with a driver profile, wherein the driver profile comprises at least one of demographics, driving experience, accident history data, a driver rating.

8. The method as claimed in claim 1, wherein clustering the vehicle data into the one or more data buckets comprises clustering the vehicle data based on at least one of traffic data, routes, a mileage pattern, city data, build characteristics, demographics, the vehicle usage pattern, the location, fuel economy statistics, the weather data, the driving style, the operating conditions, a driver rating, the commuting pattern, the vehicle make, the vehicle model or the vehicle manufacture year.

9. The method as claimed in claim 1, wherein the one or more rules is predefined by a Query Criteria Database.

10. The method as claimed in claim 1, wherein querying the one or more data buckets based on the query comprises:
comparing the query with one or more predefined query templates,
wherein
the one or more predefined query templates are mapped to the one or more data buckets; and
retrieving the vehicle data from at least one of the one or more data buckets based on comparing the query with the one or more predefined query templates.

11. A vehicle feedback server for providing dynamic vehicle feedback, the vehicle feedback server comprising:
a processor;
a memory communicatively coupled to the processor, wherein the memory stores the processor-executable instructions, which, on execution, causes the processor to:
receive vehicle data from one or more connected vehicles;
enhance the vehicle data with at least one of operating context data, situation context data and activity context data;
cluster the vehicle data into one or more data buckets based on one or more rules; and
query the one or more data buckets based on a query, wherein the query is received from a user.

12. The vehicle feedback server as claimed in claim 11, wherein the vehicle data comprises at least one of operating conditions of the vehicle or DTCs.

13. The vehicle feedback server as claimed in claim 11, wherein the operating context data comprises at least one of a time data, road conditions, speed limits, routes, weather data, altitude data or terrain data.

14. The vehicle feedback server as claimed in claim 11, wherein the situation context data comprises at least one of commuting pattern, vehicle usage pattern, crash propensity risks, parked data or traffic data.

15. The vehicle feedback server as claimed in claim 11, wherein the activity context data comprises at least one of gear positions, driving style, engine impacts due to the driving style or wear and tear thresholds.

16. The vehicle feedback server as claimed in claim 11, wherein the processor is further configured to enhance the vehicle data with a vehicle profile, wherein the vehicle profile comprises at least one of a transmission type, a fuel type, a vehicle make, a vehicle model, a vehicle manufacture year, build characteristics, spare parts status, maintenance status, mileage status or engine risk status.

17. The vehicle feedback server as claimed in claim 11, wherein the processor is further configured to enhance the vehicle data with a driver profile, wherein the driver profile comprises at least one of demographics, driving experience, accident history data, a driver rating.

18. The vehicle feedback server as claimed in claim 11, wherein the processor is configured to cluster the vehicle data into the one or more data buckets which comprises clustering the vehicle data based on at least one of traffic data, mileage pattern, city data, the build characteristics, the demographics, the vehicle usage pattern, the location data, fuel economy statistics, the weather data, the driving style, the operating conditions, the driver rating, the commuting pattern, the vehicle make, the vehicle model or the vehicle manufacture year.

19. The vehicle feedback server as claimed in claim 11, wherein the one or more rules is predefined by a Query Criteria Database.

20. The vehicle feedback server as claimed in claim 11, wherein the processor is configured to query the one or more data buckets by:
comparing the query with one or more predefined query templates, wherein
the one or more predefined query templates are mapped to the one or more data buckets; and
retrieving the vehicle data from at least one of the one or more data buckets based on comparing the query with the one or more predefined query templates.
